(19) United States
(12) Patent Application Publication
(10) Pub. No.: US 2010/0295218 A1
(43) Pub. Date: Nov. 25, 2010

(54) Process for Drying Ceramic Honeycomb Bodies

(75) Inventors: Ralf Dotzel, Nürnberg (DE); Jörg Münch, Lichtenfels (DE)

Correspondence Address: LERNER GREENBERG STEMER LLP, P O BOX 2480, HOLLYWOOD, FL, 33022-2480, US

(73) Assignee: Argillon GmbH, Redwitz (DE)

(21) Appl. No.: 12/809,852

(22) PCT Filed: Nov. 13, 2008
(86) PCT No.: PCT/EP2008/009567

§ 371 Date: Aug. 5, 2010

(30) Foreign Application Priority Data
Dec. 20, 2007 (DE) 10 2007 061 776.5

(51) Int. Cl. H05B 6/64

(52) U.S. Cl. 264/489

(57) ABSTRACT

A process for the gentle and efficient drying of a ceramic honeycomb body is specified. The process is suitable for achieving, with uniform a drying of the honeycomb body, a short drying time and low shrinkage of the honeycomb body. For this, the honeycomb body which is in a moist prefabrication state is frozen and the moisture is removed from the frozen honeycomb body at a reduced pressure.

The invention relates to a process for drying a ceramic honeycomb body.

For exhaust gas purification, both in power station furnaces and in vehicle technology, catalysts are often used for the selective reduction of nitrogen oxides. These SCR catalysts, as they are known, usually comprise a honeycomb body through which pass a multiplicity of ducts. In this case, on the one hand, SCR catalysts are used, the honeycomb body of which is formed completely from a porous catalytically active material. In other SCR catalysts, the honeycomb body itself is made from a non-catalytically active material, but carries a catalytic coating. In both instances, the honeycomb body is normally produced by the extrusion of a moist ceramic mass. The honeycomb body prefabricated in this way is subsequently dried.

Similar honeycomb bodies are also used for particle filters.

During drying, the ceramic material of the honeycomb body loses volume, this being designated below as shrinkage. Shrinkage leads to material stresses particularly in the case of uneven drying. In order to avoid the formation of stress cracks and therefore rejects, care must be taken to ensure as homogenous a drying as possible and consequently uniform shrinkage of the honeycomb body.

In one conventional method an attempt is made to achieve homogeneous drying by packaging the still moist honeycomb body into a cardboard box. The packaged honeycomb body is subsequently introduced into a drying chamber. The cardboard box protects the honeycomb body from external convection, that is to say from an air movement which would be conducive to an uneven drying of the honeycomb body. On account of the lack of air movement, the moisture essentially has to be transported away inside the cardboard box simply by diffusion. The long catalyst ducts inside the honeycomb body in this case give rise to long diffusion paths which counteract effective drying. As a result, the inner surface of the catalyst, that is to say the surface of the catalyst ducts, contributes to only a slight extent to the drying of the honeycomb body. Instead, in this method, the moisture is as far as possible discharged via the outer surface area of the honeycomb body into the surrounding air in the cardboard box and is transferred from there to the air in the drying chamber. This leads to a very long drying time in the region of several weeks.

Another problem is that, during conventional drying, the shrinkage is comparatively high. On the one hand, the result of this is that the porosity of the honeycomb body may be reduced and therefore the catalytic properties of the catalyst may be impaired. On the other hand, due to the shrinkage of the honeycomb body, even in the case of uniform drying there is still a comparatively high risk of crack formation. Moreover, packing and unpacking the honeycomb bodies in cardboard boxes entails a considerable outlay in operation terms.

The object on which the invention is based to specify a careful and at the same time efficient drying process for a ceramic honeycomb body.

This object is achieved, according to the invention, by means of the features of claim 1. In the drying process specified, the honeycomb body, present in a moist prefabricated state, for example after extrusion, is frozen, and the moisture, that is to say the water to be removed, is removed from the frozen honeycomb body under a vacuum.

The process according to the invention has a series of advantages.

Thus, the process can be carried out by simple means and with comparatively little labor. In particular, further equipment, such as, for example, cardboard boxes, may be dispensed with.

Since the honeycomb body to be dried is in the frozen state during the drying operation, a higher strength and stability of the honeycomb body are achieved, as compared with the moist prefabricated state. The honeycomb body can thus absorb higher stresses during the drying operation than in the moist state.

Moreover, it has been shown that, as a result of the drying of the catalyst body in the frozen state, particularly low shrinkage is achieved. This, on the one hand, leads to a lower risk of stress crack formation and therefore to a higher production output. On the other hand, the lower shrinkage causes a higher porosity of the dried honeycomb body in the case of a changed distribution of the pore radii, this having a positive effect on its catalytic properties. This advantage comes into effect particularly after an aging caused by high temperatures during the operation of the catalyst, since the age-induced reduction in the specific surface of the catalyst plays a smaller part on account of the ex-factory higher porosity of the honeycomb body produced according to the invention.

Since, in the frozen state, the moisture is transferred directly from the solid phase into the gas phase by sublimation, no moisture gradients occur in the honeycomb body and therefore no regions which have different shrinkage. The risk of stress crack formation is thereby further reduced.

The vacuum prevailing on the honeycomb body during the drying operation acts, furthermore, on the casing of the honeycomb body in the same way as within the catalyst ducts. The moisture is therefore no longer transported away mainly via the casing of the honeycomb body, but also via the inner walls of the honeycomb body, the transmission surface being enlarged as a result. As a result, in comparison with drying processes which are based decisively on moisture diffusion, a substantially shortened drying time is achieved. The high porosity of the honeycomb body also has a positive effect in this case. To be precise, if the sublimation limit creeps into the honeycomb body during the drying operation, sublimation takes place to an increasing extent via the pore surface which is larger by a multiple than the geometric (inner and outer) surface(s) of the honeycomb body. The drying time is thereby shortened even further.

In one version of the invention, the honeycomb body is first frozen at room pressure by lowering the ambient temperature. For this purpose, in particular, a conventional refrigerating plant, in particular a shock freezer, is employed. Alternatively, or additionally, the honeycomb body may also be frozen by application of a cold fluid, in particular gaseous or liquid nitrogen. The vacuum is in this case applied only when the honeycomb body is already in the frozen state.

In an especially advantageous alternative version of the process, by contrast, the freezing of the honeycomb body takes place simultaneously with and, in particular, by the application of the vacuum. In the latter implementation variant, the vacuum is applied in such a way that the moisture of the honeycomb body partially evaporates, so that the cooling resulting according to the Joule-Thomson effect leads to the freezing of the honeycomb body. In this process variant, the external cooling energy otherwise required for cooling the honeycomb body can be saved completely, or at least partially. If appropriate, even a specific cooling assembly may be dispensed with, with the result that the process can be carried out cost-effectively and, in particular, also becomes especially beneficial in energy terms.

In a preferred version, a solid extrudate consisting of a catalytically active material is employed as a honeycomb body. The above-described process can be applied particularly effectively to a honeycomb body which consists essentially of titanium oxide.

The atmospheric pressure in the drying chamber is preferably reduced abruptly. The honeycomb body to be dried is thereby shock-frozen. The result of this is that the advantages of the process which arise due to the frozen state of the honeycomb body, such as, for example, the higher stability and low shrinkage of the honeycomb body come into effect to a particular extent. In particular, a vacuum application is designated as abrupt in which the atmospheric pressure in the drying chamber is lowered within a time span of approximately 5 min to approximately 30 min, in particular within approximately 10 min, from room pressure (approximately 1000 mbar) to a final pressure of below 6 mbar, in particular to approximately 4 mbar.

In general, it has proved advantageous for the process, during the drying of the honeycomb body, to keep the vacuum essentially constant at less than 6 mbar. In this case, there are beneficial external conditions with regard to the desired sublimation of the ice, that is to say the direct transition from the solid phase to the gas phase. An approximately constant vacuum of about 4 mbar has proved preferable in this case in numerous tests.

In order to further accelerate the sublimation rate and consequently the drying duration of the ceramic honeycomb body, the frozen drying stock, that is to say the honeycomb body, is advantageously heated actively during drying under a vacuum. As a result of an appropriate heating of the honeycomb body, the drying times can be further shortened. It became apparent that, for example, for a honeycomb body with a diameter of 250 mm, a length of 200 mm and a wall thickness of 0.3 mm, only an additional drying time of a few hours is required.

The drying of the honeycomb body takes place under a vacuum. Consequently, convection heating is ruled out. The heating of the honeycomb body may in this respect take place either by means of heat radiation or directly by means of heat conduction. In an advantageous refinement of direct heating, the honeycomb body is laid on a carrier during the drying operation, and this carrier is heated during drying. In particular, electrical heating is appropriate in this case. A suitable carrier for the honeycomb body, is, for example, a sheet, in particular made from metal, which is brought to the corresponding temperature by means of electrical resistance heating.

Alternatively or additionally to direct heating by means of heat conduction, a radiant heating of the honeycomb body may take place, as already mentioned. Such radiant heating is carried out expediently by means of infrared radiation. For a good drying result, the honeycomb body is in this case preferably irradiated from a plurality of sides by means of suitably mounted infrared emitters.

It became apparent from numerous tests that a desired accelerated sublimation of the ice occurs when infrared radiation is used. As long as the honeycomb body still contains water and is under a vacuum, the temperature of the drying stock does not change. The temperature is coupled to the pressure according to the vapor pressure graph for water. However, as soon as all the ice or water has been removed from the honeycomb body, the temperature of the honeycomb rises. Moreover, on account of the poor thermal conductivity of a ceramic, sublimation or drying within the honeycomb body takes place markedly more slowly than on an irradiated honeycomb side. Relatively high temperature gradients over the honeycomb cross section (frozen on the inside—hot on the outside) are therefore obtained. Since the honeycomb body cannot be removed, hot, from drying without risk, a cooling step should expediently follow the drying operation under infrared radiant heating. By means of this additional cooling step, the honeycomb body is cooled to room temperature before removal.

The drying of the honeycomb body under a vacuum can thus be markedly accelerated by means of additional infrared radiation, but an additional process step before removal does necessarily have to take place. Since the drying of the honeycomb body naturally occurs from the outside inward, the core of the honeycomb body additionally always has a higher moisture level than the outer region. A sufficient drying of the center of the honeycomb body thus always leads to a complete drying of the outer regions.

The disadvantages outlined may be perfectly acceptable in terms of the invention for accelerating the drying of the honeycomb body. In a further advantageous form of the drying process, however, said disadvantages with regard to the use of infrared radiation for heating the honeycomb body during drying under a vacuum are avoided in that the honeycomb body is heated by means of electromagnetic radiation in the long, short or microwave range during the drying operation. The microwave range in this case comprises frequencies of between 300 MHz and 300 GHz. The shortwave or HF range follows the microwave range at low frequency and in this case comprises radiation down to a frequency of 3 MHz. The long wave range comprises, in particular, electromagnetic radiation with a frequency of between 30 and 300 kHz. Advantageously, radiation in the short wave range and, in particular, in the microwave range is employed. The introduction of energy by means of electromagnetic radiation ideally takes place approximately constantly over the entire honeycomb volume, so that there is no formation of temperature gradients across the honeycomb body. The radiated energy is used directly for the sublimation of the ice and not for the heating of the honeycomb. The honeycomb body in this respect remains cool.

Since drying by means of electromagnetic radiation in the specified frequency range proceeds uniformly in the entire honeycomb body, a desired degree of drying for the honeycomb body can be set, in contrast to heating by means of infrared emitters. Expediently, for this purpose, the duration and/or the energy of irradiation are/is controlled according to the desired degree of drying. The honeycomb body, may, in particular, be removed from the drying operation with a certain residual amount of moisture.

Drying by irradiation with electromagnetic radiation in the long, short and microwave ranges preferably takes place continuously in a flow process. In this case, the honeycomb bodies are subjected continuously, on an assembly line principle, to the drying operation, using electromagnetic radiation. In a further advantageous refinement, continuous drying is implemented by means of a belt dryer. In this case, the honeycomb bodies are moved continuously, for drying and for irradiation, into the belt dryer and leave the latter after running through the drying stage. Moreover, a belt dryer affords the major advantage that each individual honeycomb body is moved through different zones of the radiated electromagnetic field, so that approximately homogeneous introduction of radiation is ensured for each honeycomb body. In order further to reduce the effects of the inhomogeneity of the radiated field in terms of the drying result, it is recommended additionally to rotate the honeycomb body during its run through the drying operation or during irradiation. The natural inhomogeneity of a microwave field generated, for example, according to the prior art thus no longer has any appreciable influence on the drying result.

Furthermore, the evacuated drying chamber is advantageously heated during the drying operation. This advantageously leads to an increased sublimation rate and consequently to a shortened drying time.

Exemplary embodiments of the invention are explained in more detail below.

### EXAMPLE 1

First, by the extrusion of a moist catalyst material which consists of titanium oxide with approximately 20% of admixtures, a honeycomb body for an SCR catalyst is produced. The honeycomb body has, for example, a diameter of approximately 150 mm, a length of approximately 100 mm and an average wall thickness of approximately 0.3 mm. After the extrusion operation, the honeycomb body is in a moist prefabricated state.

The honeycomb body prefabricated in this way is introduced into an evacuable drying chamber. The atmospheric pressure in the drying chamber is reduced within about 10 minutes from room pressure to a final pressure of approximately 4 mbar, the honeycomb body freezing, with the moisture stored in it still being partially evaporated. The honeycomb body is then dried at said final pressure over a drying time of about 10 hours and at a temperature of 60° C., the moisture to be removed being sublimated during this drying time. The moisture extracted is frozen out in a condensation chamber adjoining the drying chamber.

### EXAMPLE 2

A honeycomb body of the composition described above, with a diameter of 250 mm, a length of approximately 200 mm and an average wall thickness of approximately 0.3 mm, is frozen according to example 1 and is dried under a vacuum of approximately 4 mbar. For drying, the honeycomb body runs through a belt dryer, in which a microwave field with a power of 650 watts is generated along the drying stage. Due to the volumetric introduction of heat as a result of the microwaves, a drying time of only 3.5 hours is achieved. If appropriately higher powers are employed, even drying times to below 1 hour can be achieved.

1-12. (canceled)

13. A method of drying a porous ceramic honeycomb body for a catalyst or a particle filter, the process which comprises:
providing a honeycomb body in a moist prefabricated state;
freezing the moist honeycomb body to form a frozen honeycomb body;
removing moisture from the frozen honeycomb body under a vacuum in a drying process;
heating the honeycomb body by way of electromagnetic radiation selected from radiation in the long wave, short wave, or microwave range during the drying process; and
thereby controlling at least one of a duration and an energy of the electromagnetic radiation in accordance with a desired degree of drying of the honeycomb body.

14. The method according to claim 13, which comprises applying the vacuum to the moist honeycomb body by way of a pressure change causing the moisture to be removed to freeze as a result of the pressure change.

15. The method according to claim 13, which comprises placing the moist honeycomb body in a drying chamber and abruptly reducing an atmospheric pressure in the drying chamber to thereby freeze the moist honeycomb body.

16. The method according to claim 13, wherein the honeycomb body is a solid extrudate consisting of catalytically active material.

17. The method according to claim 16, wherein the honeycomb body consists essentially of titanium oxide.

18. The method according to claim 13, which comprises maintaining the vacuum substantially constant at a pressure of less than 6 mbar during the drying process.

19. The method according to claim 13, which comprises performing the drying process in a drying chamber and heating the drying chamber during the drying process.

20. The method according to claim 13, which comprises placing the honeycomb body on a carrier during the drying process and heating the carrier during the drying process.

21. The method according to claim 13, which comprises electrically heating the carrier during the drying process.

22. The method according to claim 13, which comprises continuously drying under electromagnetic radiation in a flow process.

23. The method according to claim 22, which comprises transporting the honeycomb body through a belt dryer and continuously drying the honeycomb body during a run through the belt dryer.

24. The method according to claim 23, which further comprises rotating the honeycomb body during the run through the belt dryer.
